(19) United States
(12) Patent Application Publication
(10) Pub. No.: US 2006/0125403 A1
(43) Pub. Date: Jun. 15, 2006

(54) Display device having an electron gun with pre-focusing lens portion

(75) Inventor: Heidrun Steinhauser, Eindhoven (NL)

Correspondence Address: LAHIVE & COCKFIELD, 28 STATE STREET, BOSTON, MA, 02109, US

(73) Assignee: LG. Philips Displays, Eindhoven (NL)

(21) Appl. No.: 10/539,921

(22) PCT Filed: Dec. 12, 2003
(86) PCT No.: PCT/EP03/14476

§ 371 Date: Jan. 10, 2006

(30) Foreign Application Priority Data
Dec. 19, 2002 (EP) 02080367.2

(51) Int. Cl. H01J 29/96

(52) U.S. Cl. 315/3

(57) ABSTRACT

This invention relates to a display device comprising a cathode ray tube (1), the cathode ray tube having an electron gun (7) comprising a pre-focusing lens portion, for generating a pre-focusing lens field (22), and a main lens portion, for generating a main lens field (23). The electron gun (7) further comprises an additional grid (10), being positioned in proximity with said main lens portion, whereby a potent Vgx is arranged to be applied to said additional grid (10), for generating, together with one of the potentials Vfoc or Vdyn, an additional lens field in proximity with said main lens field, whereby, in operation, the main lens field and the additional lens field is arranged to cooperate to form an effective main lens field.

This invention relates to a display device comprising a cathode ray tube, the cathode ray tube having an electron gun comprising a pre-focusing lens portion, for generating a pre-focusing lens field, and a main lens portion, for generating a main lens field.

This invention also relates to a cathode ray tube and an electron gun for use in such a display device.

A display device as described above in the opening paragraph is for example disclosed in the patent document WO 02/45120. This document essentially discloses a display device having an electron gun, comprising a pre-focusing lens portion, for generating a pre-focusing lens field, and a main lens portion, having means for generating a main lens field.

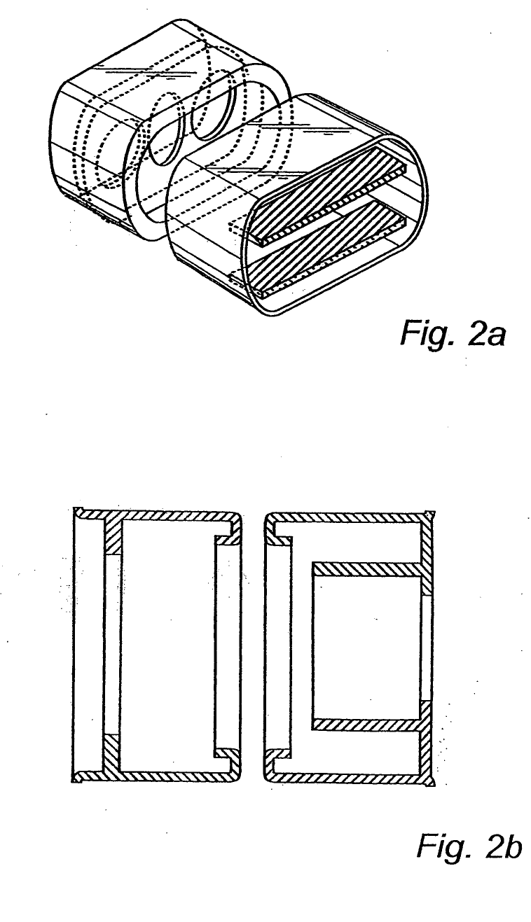

However, recently there has been an increasing demand for slim or even super-slim cathode ray tubes. In order to achieve this, shorter electron guns are desired. One way of achieving a shorter electron gun is to increase the strength of the main lens. However, in order to achieve this, a lower potential Vfoc needs to be applied to the main lens, which may be disadvantageous. Also, in many cathode ray rube concepts, a regulated astigmatism (high or low) is desired, commonly resulting in complex mechanical constructions. An example of this is disclosed in FIG. 2, disclosing a main lens, comprising a field forming electrode part as well as a second part having a pair of field-adjusting electrodes formed as wings. However, a more simple construction is desired.

Hence, it is an object of this invention to provide a display device having a relatively short electron gun, which may be utilized either to make the display slimmer or to reduce the deflection angle realizing the same depth.

An alternative object is to provide a display device having an electron gun with a tunable astigmatism, so that an electron gun may be achieved, having either comparatively high or low astigmatism.

Yet another object of this invention is to provide a display device with an electron gun having a mechanically simple construction.

The above and other objects are at least in part achieved by the display device according to the invention as defined in claim 1. The invention is based on the realization that a potentially shorter gun with a tunable astigmatism may be achieved by adding an additional lens close to the main lens, and in that way obtain an effective lens with higher strength than the main lens.

This is achieved by a display device by way of introduction, being characterized in that the electron gun further comprises an additional grid, being positioned in proximity with said main lens portion, whereby a potential Vgx is arranged to be applied to said additional grid, for generating, together with one of the potentials Vfoc or Vdyn, an additional lens field in proximity with said main lens field, whereby, in operation, the main lens field and the additional lens field is arranged to cooperate to form an effective main lens field.

The potentials Vfoc and Vdyn are understood to be electric potentials applied to an electrode of the main lens portion, said potentials defining the main lens field in cooperation with at least an anode voltage Va. In case the electron gun is a non-DAF gun, a static electric potential Vfoc is applied to the electrode of the main lens portion, whereas in the case of a DAF-type electron gun a dynamic electric potential Vdyn is applied.

By using a simple grid insert in the electron gun, a wide range of astigmatism may be achieved, using a simple mechanical construction. Moreover, as the additional lens field will cooperate with the main lens field, an efficient main lens field will be achieved being stronger than the main lens itself. Thereby a shorter gun may be realized, still avoiding the drawback of applying a lower Vfoc to a main lens grid and according to the invention, a conventional main lens may be used.

Preferably, said pro-focusing lens portion comprises a first electrode and a second electrode, whereby the potential Vgx applied to said additional grid is equal to the potential Vg2 applied to said second electrode, the potential Vg2 being in the range of 350-1500 V, preferably about 700 V. Thereby, a potentially short gun with a tunable astigmatism, may be realized using a commonly used, readily available voltage.

In a preferred embodiment, a so-called bleeder gun has a main lens portion that comprises a distributed composed field lens. In such a gun, the main lens portion comprises at least three electrodes, and the main lens field is also defined by an electric potential Vgi applied to an intermediate electrode of said at least three electrodes.

In this case, preferably, the potential Vgx applied to said additional grid is equal to the potential Vgi applied to the intermediate grid of the distributed composed field lens, wherein Vgi is within the range of 40% to 60% of the potential Va. Preferably, Vgi has a value of about 50% of the potential Va, being the anode voltage. Also in this case, a potentially short gun with a tunable astigmatism, may be realized using a commonly used, readily available voltage in the electron gun.

Suitably, the additional lens field generated by the additional grid is arranged to be an astigmatic lens field. The strength of the additional lens in the horizontal direction and the amount of astigmatism may be designed independently. Moreover, said electron gun further suitably comprises a dynamic astigmatism and focus portion, and said additional grid is arranged between the dynamic astigmatism and focus portion and the main lens portion. Alteratively, said electron gun further comprises a dynamic astigmatism and focus portion, and said additional grid is arranged between the dynamic astigmatism and focus portion and the pre-focussing lens portion, in close profanity with the dynamic astigmatism and focus portion. Preferably, the electron gun also comprises a dynamic beam forming section.

The above and other objects of the invention is at least in part achieved by a cathode ray tube device for use in a display device as described above and by an electron gun for use in a device as described above.

These and other aspects of the invention will be apparent from and elucidated by way of non-limiting examples with reference to the drawings and the embodiments of the invention hereinafter described.

In the drawings:

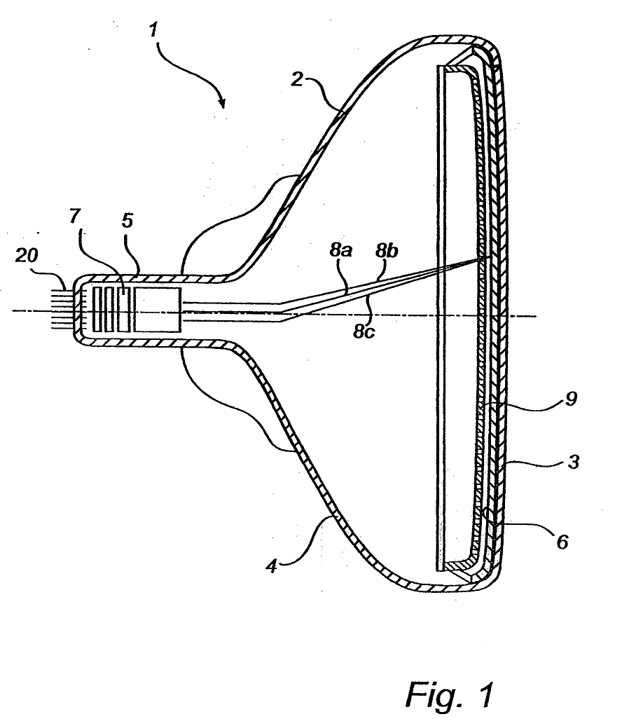

FIG. 1 is a schematic sectional view of a display device,

FIG. 2 is a schematic sectional view of an electron gun in accordance with prior art,

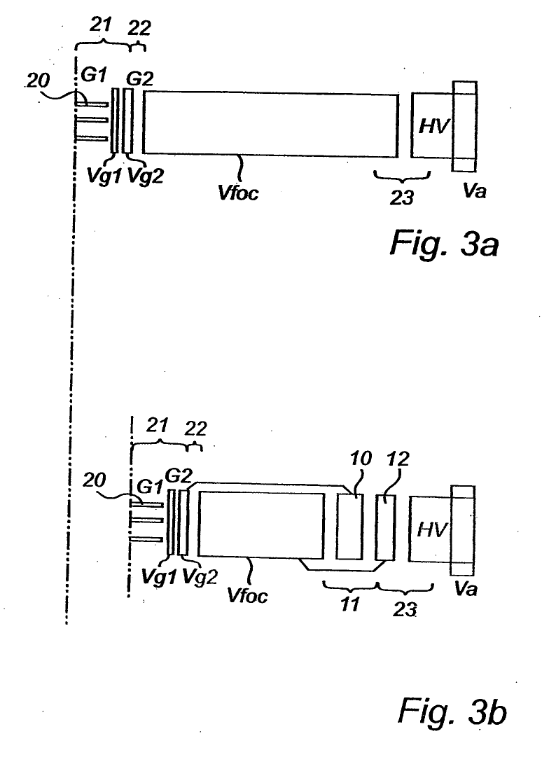

FIG. 3a is a schematic view of the basic concept for a non-DAF electron gun with a CFL main lens, in accordance with prior art, while FIG. 3b is a schematic view of a modified non-DAF electron gun comprising a first embodiment of the invention,

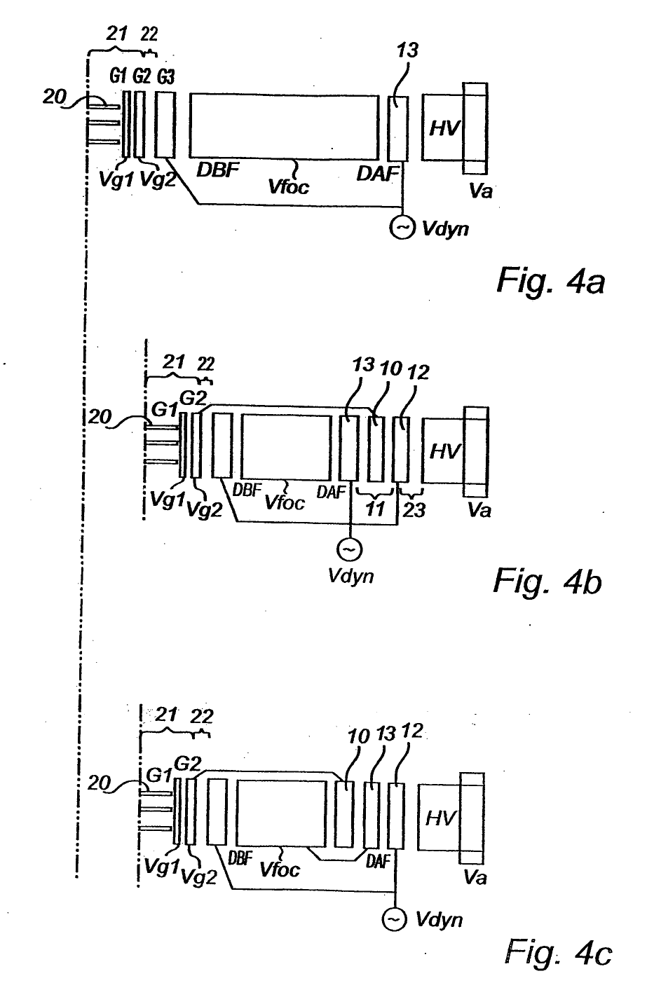

FIG. 4a is a schematic view of the basic concept for a DAF-DBF electron gun with a CFL main lens, in accordance with prior art, while FIG. 4b is a schematic view of a modified DAF-DBF electron gun comprising a second embodiment of the invention, and FIG. 4c is a schematic view of a modified DAF-DBF electron gun comprising a third embodiment of the invention,

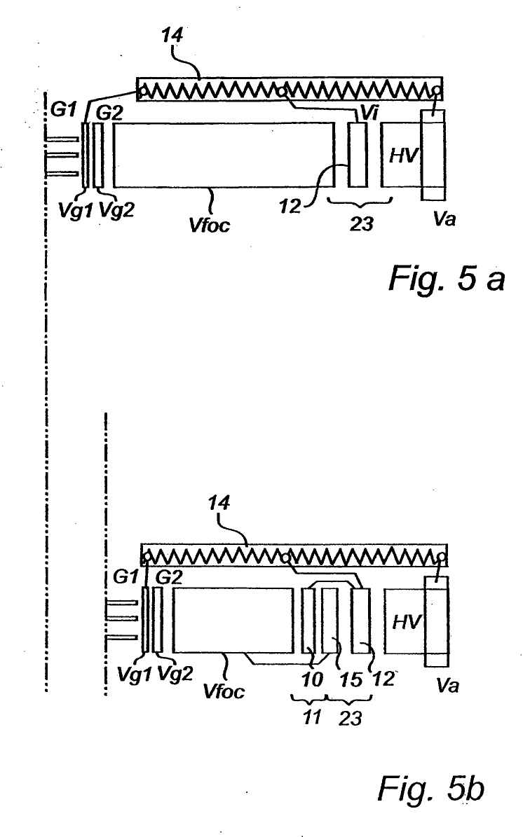

FIG. 5a is a schematic view of the basic concept for a non-DAF electron gun with a DCFL main lens, in accordance with prior art, while FIG. 5b is a schematic view of a modified non-DAF electron gun comprising a fourth embodiment of the invention,

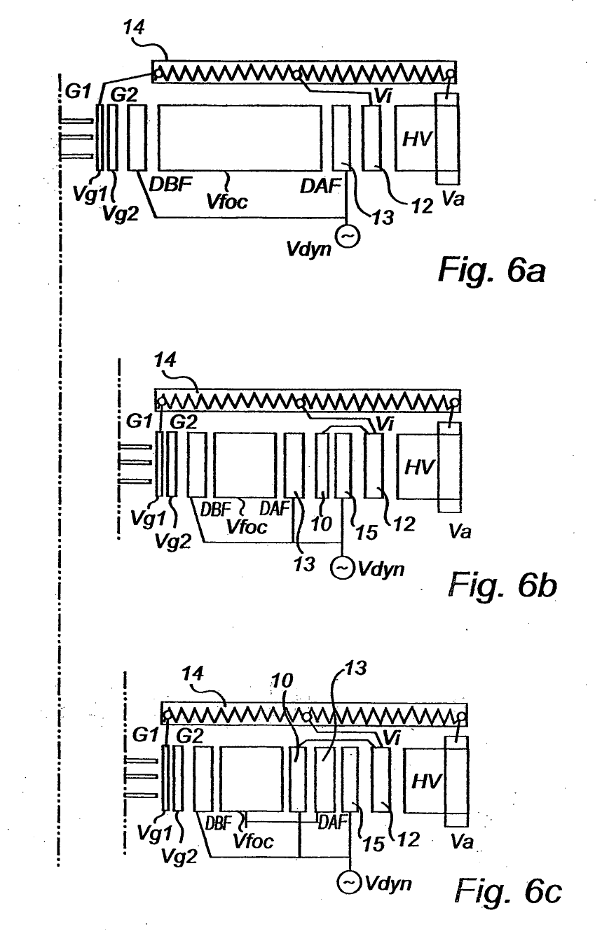

FIG. 6a is a schematic view of the basic concept for a DAF-DBF electron gun with a DCFL main lens, in accordance with prior art, while FIG. 6b is a schematic view of a modified DAF-DBF electron gun comprising a fifth embodiment of the invention, and FIG. 6c is a schematic view of a modified DAF-DBF electron gun comprising a sixth embodiment of the invention,

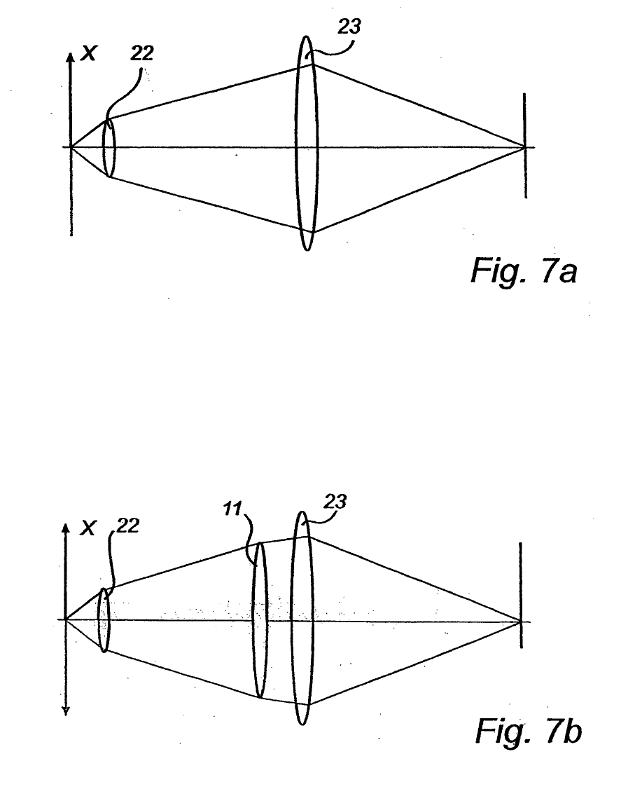

FIGS. 7a and 7b is a schematic drawing illustrating the basic principle behind the present invention, where FIG. 7a illustrates the prior art and FIG. 7b illustrates the invention.

The basic construction of a prior art display device, with an electron gun, in which the invention may be implemented will hereinafter be described with reference to FIG. 1.

A display tube 1, shown in FIG. 1 essentially comprises an evacuated glass envelope 2 having a display window 3, a funnel-shaped part 4 and a neck portion 5. An electron gun 7 is arranged in the neck portion 5, and is arranged to generate one or more electron beams, commonly three electron beams 8a, 8b and 8c. The outer surface of the display window 3 may be either flat or curved. On an inner side of the display window, a display screen 6 having a pattern of for example lines or dots of luminescent phosphor elements is arranged. The luminescent phosphor elements are arranged to luminance in different colors, such as for example red, green and blue (i.e. forming a so-called RGB display). The electron beams 8a, 8b, 8c described above are generated by the electron gun 7 and are thereafter deflected across the display screen 6 by means of a deflection unit 11, positioned around the neck portion 5 and/or the funnel-shaped portion 4 of the display tube 1. The deflection unit ensures a systematic scanning of the display screen 6 by the electron beams 8a, 8b, and 8c. Subsequently the beams are arranged to pass through a shadow mask 9, being arranged in front of the display window 3, so that the beams hit the phosphor elements described above, whereby light is generated and emitted. Essentially, the shadow mask 9 comprises a plate provided with apertures. The electron beams 8a, 8b and 8c are arranged to travel at an angle in respect to each other, and hence, each electron beam will impinge on phosphor elements of one single color only.

The electron gun 6 in accordance with the invention will hereinafter be closer described, from the starting point of a prior art non-DAF electron gun, having a CFL main lens as disclosed in for example FIG. 3a. Several sections can be distinguished in such an electron gun. Basically, the main regions are a triode portion 21 (i.e. a cathode 20 and two electrodes, G1 and G2), a pre-focus lens section 22, being formed by an electric field between the electrode G2 and a third electrode G3, and a main lens 23, being formed by an electric field between the third electrode G3 and a fourth electrode G4. The main lens 23 may end in a so called main lens modifier (MFM), which acts as an “extra grid” at anode voltage. More complicated guns, as is disclosed in FIG. 4a and FIG. 5a, may also include a dynamic astigmatism and focus section (DAF) and potentially also a dynamic beam forming region (DBF). The DAF section may be realized by using an additional electrode, being placed between the electrodes G3 and G4, the electrodes together forming a so-called quadrupole lens.

In accordance with the invention, three embodiments of which is disclosed in FIGS. 3b, 4b and 4c, the electron gun arrangement further comprises an additional grid 10, being positioned in proximity with said main lens portion, whereby a potential Vg2, being the same as is applied to the second electrode or grid G2, is ranged to be applied to the additional grid 10, for generating, together with one of the potentials Vfoc or Vdyn, applied to a main lens grid 12, an additional lens field 11 in proximity with said main lens field 23. This is schematically shown in FIG. 7b. Thereby, in operation, the main lens field 23 and the additional lens field 11 is arranged to cooperate to form an effective main lens field. The voltage Vg2 typically has a value of 700 V, but may be chosen within the range 350-1500 V. The advantage of using Vg2 for the additional grid is that this potential is already available in this kind of electron gun, making the inventive arrangement simple to implement, both mechanically and electrically.

In the first embodiment (non-DAF gun) disclosed in FIG. 3b, the potential Vfoc is applied to the main lens grid 12, and the additional lens field 11 is arranged to be formed directly in front of the main lens field 23.

In the second embodiment (DAF-DBF gun) disclosed in FIG. 4b, the potential Vdyn is applied to the grid 12, and the additional lens field 11 is arranged to be formed directly in front of the main lens field. Hence, the additional grid 10 is sandwiched between a DAF forming grid and the main lens grid 12, both being held at the potential Vdyn.

In the third embodiment (DAF-DBF gun) disclosed in FIG. 4c, the potential Vdyn is applied to the grid 12. However, as compared to the embodiment disclosed in FIG. 4b, the positions of the additional grid 10 and the DAF forming grid 13 is interchanged, whereby the additional lens field 11 is arranged to be formed directly in front of the DAF forming grid 13 as seen from the cathode 20.

Moreover, the invention may also be applied to so called intermediate bleeder guns. Examples of prior art intermediate bleeder guns are disclosed in FIG. 5a (non-DAF gun), and FIG. 6a (DAF-DBF guns). In all three cases, the main lens is a so-called DCFL main lens (distributed composed field lens). In this kind of gun, an intermediate bleeder means is connected so that the potential Vg1 is applied to one end, and the potential Va is applied to the other end. The potential Vg1 is commonly applied to ground potential, while the potential Va commonly is comparatively large, for example 30-32 kV. As is disclosed in the examples in FIGS. 5a, and 6a, an DCFL main lens forming grid 12 is connected to the bleeder means via an intermediate contact, providing a potential Vgi. Preferably, the contact provides a potential Vgi of about 50% of the anode voltage Va, or at least within the interval 40%-60% of the anode voltage Va. Due to the above mentioned values of Va, this results in values of Vgi of about 12-20 kV. However, in accordance with the invention, three alternative embodiments of which is disclosed in FIGS. 5b, 6b and 6c, the electron gun arrangement further comprises an additional grid 10, being positioned in proximity with said main lens portion, whereby a potential Vgi, being the same as is applied to the main lens grid 12, is arranged to be applied to the additional grid 10, for generating, together with one of the potentials Vfoc or Vdyn, applied to a focus grid 15, an additional lens field 11 in proximity with said main lens field 23. Thereby, in operation, the main lens field 23 and the additional lens field 11 is arranged to cooperate to form an effective main lens field. The advantage of using Vgi for the additional grid is that this potential is already available in this kind of electron gun, making the inventive arrangement simple to implement, both mechanically and electrically.

In a fourth embodiment (non-DAF gun) disclosed in FIG. 5b, the potential Vgi is applied to the main lens forming grid 12 and to the additional grid 10. Moreover the potential Vfoc is applied to the focus grid 15, being sandwiched between the main lens forming grid 12 and the additional grid 10. Hence, the additional lens field 11 is arranged to be formed directly in front of the distributed composed main lens field.

In a fifth embodiment (DAF-DBF gun) disclosed in FIG. 6b, the potential Vgi is applied to the main lens forming grid 12 and to the additional grid 10. A DAF portion is further arranged in front of the additional grid 10, as seen from the cathode. Moreover, the potential Vdyn is applied to the focus grid 15, being sandwiched between the main lens forming grid 12 and the additional grid 10. The potential Vdyn is also applied to the DAF section, as seen in FIG. 6b. Also in this case, the additional lens field is arranged to be formed directly in front of the distributed composed main lens field.

In a sixth embodiment (DAF-DBF gun) disclosed in FIG. 6c, the potential Vgi is applied to the main lens forming grid 12 and to the additional grid 10. However, as compared to the embodiment disclosed in FIG. 6b, the positions of the additional grid 10 and the DAF forming grid 13 are interchanged, whereby the additional lens field 11 is arranged to be formed directly in front of the DAF forming grid 13 as seen from the cathode 20.

In all of the above-described embodiments of the invention, an additional lens is formed in front of the main lens, as is schematically shown in FIG. 7, in proximity with the main lens, using potentials that are readily available in this kind of electron gun. The additional lens and the main lens together forms an effective main lens being stronger than the main lens itself and hence the electron gun may be made shorter. The inventive solution further has a mechanically simple construction, as the additional grid may be realized in the same way as for example DAF plates or the like, being commonly used in this type of electron guns. Although the construction is simple, it is possible to achieve high as well as low astigmatism, hence covering a wide range.

The present invention should not be considered as being limited to the above-described embodiments thereof, but rather includes all possible variations covered by the scope defined by the appended claims. Especially it shall be noted that the additional lens is to be positioned in proximity with, or in close proximity with, the main lens. This shall be construed as a positioned being at a comparatively large distance from the pre-focussing section of the electron gun. Moreover, it shall be noted that, it is possible to apply other potentials to the additional grid than the once exemplified above, in order to form the additional lens. For example, the potential applied to the first grid G1 may be used.

It shall also be noted that the term “electron gun” as used in this document shall not be construed in a limiting sense. Especially, it shall be noted that both electron guns generating a single electron beam (in a monochromatic tube) as well as electron guns generating a plurality of electron beams (such as in the color display tube described above), is to be included by this term.

1. A display device comprising a cathode ray tube, the cathode ray tube having an electron gun comprising:
a pre-focusing lens portion, for generating a pre-focusing lens field, and
a main lens portion, for generating a main lens field,
characterized in that the electron gun further comprises an additional grid being positioned in proximity with said main lens portion, whereby a potential Vgx is arranged to be applied to said additional grid, for generating, together with one of the potentials Vfoc or Vdyn, an additional lens field in proximity with said main lens field, whereby, in operation, the main lens field and the additional lens field is arranged to cooperate to form an effective main lens field.

2. A display device as in claim 1, wherein said pre-focusing lens portion comprises a first electrode (G1) and a second electrode (G2), whereby the potential Vgx applied to said additional grid is equal to the potential Vg2 applied to said second electrode (G2), the potential Vg2 being in the range of 350-1500 V.

3. A display device as in claim 1, wherein said main lens portion comprises a distributed composed field lens, whereby the potential Vgx applied to said additional grid is equal to a potential Vgi applied to an intermediate grid of the distributed composed field lens, wherien Vgi is within the range of 40% to 60% of the potential Va.

4. A display device as in claim 1, wherein the additional lens field generated by the additonal grid is arranged to be an astigmatic lens field.

5. A display device as in claim 1, wherein said electron gun further comprises a dynamic astigmatism and focus portion (DAF), and said additional grid is arranged between the dynamic astigmatism and focus portion and the main lens portion.

6. A display device as in claim 1, wherein said electron gun further comprises a dynamic astigmatism and focus portion (DAF), and said additional grid is arranged between the dynamic astigmatism and focus portion and the pre-focusing lens portion, in close proximity with the dynamic astigmatism and focus portion.

7. A display device as in claim 1, wherein the electron gun further comprises a dynamic beam forming section (DBF).

8. A cathode ray tube device for use in a display device, the cathode ray tube having an electron gun comprising:
a pre-focusing lens portion, for generating a pre-focusing lens field, and
a main lens portion, for generating a main lens field.
characterized in that the electron gun further comprises an additional grid being positioned in proximity with said main lens portion, whereby a potential Vgx is arranged to be applied to said additional grid, for generating, together with one of the potentials Vfoc or Vdyn, an additional lens field in proximity with said main lens field, whereby, in operation, the main lens field and the additional lens field is arranged to cooperate to form an effective main lens field.

9. An electron gun comprising:
a pre-focusing, lens portion, for generating a pre-focusing lens field, and
a main lens portion, for generating a main lens field,
characterized in that the electron gun further comprises an additional grid being positioned in proximity with said main lens portion, whereby a potential Vgx is arranged to be applied to said additional grid, for generating, together with one of the potentials Vfoc or Vdyn, an additional lens field in proximity with said main lens field, whereby, in operation, the main lens field and the additional lens field is arranged to cooperate to form an effective main lens field.
